(19) United States
(12) Patent Application Publication
(10) Pub. No.: US 2017/0103192 A1
(43) Pub. Date: Apr. 13, 2017

(54) SECURE CODE DELIVERY

(71) Applicant: Renesas Electronics America Inc., Santa Clara, CA (US)

(72) Inventors: Brandon Cranford Hussey, Durham, NC (US); Jon Matthew Brabender, Cary, NC (US); John L. Dallaway, Cambridge (GB); James Mark Deadman, Kent (GB); Mark Goodchild, Wargrave (GB); Noriyuki Mori, San Mateo, CA (US); Murthy L. Vedula, Sunnyvale, CA (US)

(21) Appl. No.: 15/291,766

(22) Filed: Oct. 12, 2016

Related U.S. Application Data
(60) Provisional application No. 62/240,341, filed on Oct. 12, 2015.

(51) Int. Cl. G06F 21/12; G06F 21/57; G06F 12/14; G06F 9/44; G06F 21/62

(52) U.S. Cl. CPC G06F 21/125; G06F 8/30; G06F 21/6209; G06F 8/70; G06F 12/1408; G06F 8/71; G06F 21/57; G06F 2221/2107; G06F 2221/2141; G06F 2212/1052

(57) ABSTRACT

A method and apparatus for secure code delivery. In one embodiment the method is implemented on a computer system, and includes reading an access privilege from a first set of access privileges, wherein the first set of access privileges corresponds to a first file that comprises first encrypted source code. The first encrypted source code is decrypted to produce first decrypted source code. A determination is made as to whether the first access privilege is set to a first state or a second state. If the first access privilege is set to the first state, a first software development tool is permitted to access and process the first decrypted source code. If the first access privilege is set to a second state, the first software development tool is denied access to decrypted source code.

### RELATED APPLICATIONS

This application claims the domestic benefit under Title 35 of the United States Code §119(e) of U.S. Provisional Patent Application Ser. No. 62/240,341 filed on Oct. 12, 2015, entitled “Secure Source Code Delivery and Debugging” which is hereby incorporated by reference in its entirety and for all purposes as if completely and fully set forth herein.

### BACKGROUND OF THE INVENTION

Embedded systems are computer systems that do not look like computer systems to most people. They are hidden within and form a part of larger mechanical or electrical systems such as medical devices, appliances, office equipment, etc. Today more processors are used in embedded systems than in personal computers. And embedded systems are becoming smarter and more connected using wired or wireless connections as we enter the Internet of Things (IoT) age.

Embedded systems include hardware and software. The hardware typically includes a microcontroller unit (MCU), which is essentially a computer on a single integrated circuit. MCU architectures vary widely. However, nearly all contain memory (e.g., Flash memory) for storing embedded software, and one or more central processing units (CPUs) for executing instructions of the embedded software. The size of the Flash memory is limited to reduce MCU cost. The small size substantially constrains the size of embedded software an MCU can hold.

MCUs contain additional hardware such as random access memory (RAM), configuration registers, and programmable peripherals such as general purpose timers, general purpose input/output (GPIO) ports, serial communication controllers, Ethernet controllers, DMA controllers, LCD controllers, etc.

MCUs are often embedded in other machinery or products, and include embedded software specifically designed to control or otherwise interface with the specific product in which the microcontroller is embedded, often with real-time computing constraints. Embedded software can be stored in Flash memory on the MCU, after the MCU has been manufactured and sold. Thus, MCUs stand in contrast to the microprocessors used in general purpose computers or other general purpose applications.

Embedded software developers often face a difficult task when attempting to build or modify embedded software for use in a specific dedicated product (e.g., a medical device). The process of developing embedded software can be a time consuming and complicated. The process includes the steps of writing or modifying code, translating code, debugging code, and programming an MCU with translated and debugged code to build a first functional prototype.

Embedded software development is more efficient through use of integrated development environments (IDEs). An IDE is an application program that executes on a general purpose computer and provides comprehensive facilities for software development. IDEs present a single program in which most or all software development is done. IDEs include software development tools that are chained together to make embedded software development easier. The tools typically consists of a source code text editor, build automation tools including a complier and linker, and a debugger. Additional tools are contemplated.

A source code editor is a computer program for editing source code via a graphical user interface (GUI). Source code is a collection of instructions, (possibly with comments), that is written using a human-readable programming language such as C. The present invention will be described with reference to a source code editor for writing or editing source code in C, it being understood the present invention should not be limited thereto. A higher level programming language like C is for the most part independent of an MCU's specific architecture.

Source code must be translated into binary object code before it can be executed on a CPU. A compiler is a computer program that can translate or “compile” source code into binary object code (hereinafter object code). In contrast to source code, object code is not human-readable. Object code represents processor instructions using the binary number system's two binary digits, 0 and 1. Object code assigns a bit string to each instruction. For most compilers, an object file (i.e., .o file) is the result of compiling a source code file (i.e., .c file). A compiler can be configured to optimize the resulting object code for use with a particular MCU. Compilers can take into account various constraints and considerations such as limited memory that is typically available on an MCU. For example, a compiler can be configured to produce code that will run faster on a given MCU or occupy less Flash memory. Sometimes source code does not compile properly. A good IDE allows a developer to click on an error message produced by the compiler and have the source code with the highlighted offending instruction pop up for editing in the source code editor. As will be more fully described, embedded software may be built from many software components after they have been compiled A linker can used to combine these components in object code format into a unified executable image (i.e., .exe file).

Even the most experienced developers usually do not get it right on their first try. Certain errors, often called bugs, can occur in embedded software, causing it to function in an unexpected manner. For example, software being tested may crash when it tries to implement an instruction not available on the CPU, or the software may crash when it attempts to access unavailable or protected memory. Sometimes these errors are easy to fix, while other bugs are very difficult to trace. This is especially true for large software projects that consist of several thousand lines of code. Debuggers are used to test and debug code for problems.

Common debuggers provide features that include the capability of examing an MCU's RAM; pausing or stopping the execution of code at defined instruction locations by setting breakpoints; single-stepping (execute one instruction at a time) through the code; and looking at a history of executed code (trace). When software crashes, the debugger can highlight the offending source code in a view if the debugger is a source-level debugger, which is commonly seen in IDEs. This helps the developer to identify and correct the bug that caused the crash.

IDEs are designed to maximize developer productivity by providing tight-knit tools with similar user interfaces. IDEs present a single program in which all development is done. This contrasts with software development using unrelated tools. An IDE puts all of the previously discussed tools under one common unified user interface, so that it becomes possible to make a code change with a few mouse clicks, instead of dozens.

### SUMMARY OF THE INVENTION

A method and apparatus for secure code delivery. In one embodiment the method is implemented on a computer system, and includes reading an access privilege from a first set of access privileges, wherein the first set of access privileges corresponds to a first file that comprises first encrypted source code. The first encrypted source code is decrypted to produce first decrypted source code. A determination is made as to whether the first access privilege is set to a first state or a second state. If the first access privilege is set to the first state, a first software development tool is permitted to access and process the first decrypted source code. If the first access privilege is set to a second state, the first software development tool is denied access to decrypted source code.

### BRIEF DESCRIPTION OF THE DRAWINGS

The present invention may be better understood in its numerous objects, features, and advantages made apparent to those skilled in the art by referencing the accompanying drawings.

FIG. 1 is a block diagram illustrating an example system employing one embodiment of the present invention.

FIG. 2 is block diagram illustrating an example of a secure code delivery system employed in FIG. 1.

FIG. 3 is a flow chart of an example process implemented by the secure code delivery system shown in FIG. 2.

FIG. 4 is a block diagram illustrating an example of a secure IDE employed in FIG. 1.

FIG. 5 is a flow chart of an example process implemented by the secure IDE shown in FIG. 4.

The use of the same reference symbols in different drawings indicates similar or identical items.

### DETAILED DESCRIPTION

Embedded software typically includes an application written for a specific purpose, and system software (hereinafter software platform) that supports the application. The software platform is logically positioned between the application and hardware of the MCU. A software platform is an abstraction layer that hides the details an MCU. With little or no modification, a software platform can support an application on any one of several MCUs that have different hardware features.

The software platform can be built in layers using preexisting components. A software platform typically includes application programming interfaces (APIs), middleware components (e.g., a communication stack), device drivers, and a board support package. It should be noted that software platform is not limited to these components. All of these components can be delivered by one vendor, after the vendor extensively tests the components to insure they meet industry standards and interoperability with each other and the underlying MCU.

In some embodiments, the software platform also includes a real-time operating system (RTOS). An RTOS is an operating system (OS) intended to serve real-time application data as it comes in, typically without buffering delays. An RTOS has an advanced algorithm for scheduling tasks. A key characteristic of an RTOS is the level of its consistency concerning the amount of time it takes to accept and complete a task. An RTOS that can absolutely guarantee a maximum time for any task is commonly referred to as “hard real-time,” while an RTOS that can only guarantee a maximum most of the time are referred to as “soft real-time.” An important difference between most embedded operating systems (e.g., RTOS) and desktop operating systems is that the embedded operating system and other components of the software platform, are usually statically linked together with the application into a single executable, which can be stored in Flash memory of an MCU.

APIs are another type of software platform component. An API defines a set of routines, protocols and tools needed for an application. An API should be created so that it is generic and implementation independent. This allows for the API to be used in multiple applications with changes only to the implementation of the API and not the general interface or behavior. Device drivers create abstract, high level functions that can be used to make the hardware do something without having to have a detailed knowledge of how the hardware is doing it. A driver is a great way to allow developers who aren't experts in the lower lying hardware to still write useful application code without knowledge of the nitty-gritty details. This can come in extremely handy for developers who work with multiple MCU hardware architectures and need to port applications from one to another.

Middleware is typically in data communication between APIs and drivers, and is a term that encompasses several types of software platform components. Middleware is often viewed as software that has been abstracted out of the application layer for a variety of reasons such as to allow reusability with other applications, to decrease development costs or time by purchasing it off-the-shelf (OTS) from a third party software vendor, or to simplify application code. Integrating middleware components into the software platform makes it easier for developers to implement communication, input/output, etc., which in turn them to focus on the specific purpose of their application.

Although extremely difficult and time consuming, embedded software developers could write “bare metal” software, which means an application that interacts directly with MCU hardware and without any intermediate software components like device drivers. Because embedded software development has reached a cost point and capability stand point, embedded software developers don't do this. Today developers can integrate preexisting OTS components to create a software platform using integrated development environments (IDEs).

OTS software could be provided to developers in source code format or in object code format. Developers prefer to receive OTS software in source code form for a variety of reasons. One reason relates to compiler optimization. Compilers can be configured with variable settings to compile source code in a manner that optimizes the resulting object code in terms of speed, size, etc. For example, a developer can configure a compiler to compile source code into object code that requires less Flash memory for storage, or a developer can configure a compiler to compile source code into object code that runs faster on one MCU versus another MCU with different features. But developers cannot optimize OTS software platform components when compiled (i.e., in object code format). Accordingly, developers prefer buy source code OTS software components. Another reason developers prefer OTS software in source code format relates to debugging. Debuggers detect errors in embedded software projects. When software crashes because of a bug, the offending source code instruction can be highlighted in a display. Source code is written in a human-readable programming language. Object code is binary and virtually impossible to read. It would be difficult for developers to understand the nature of an error identified by a debugger when the instruction that caused the error is displayed in object code format. In other words, developers can more easily understand and correct errors in their projects when they can see source code instructions that are tied to the errors.

While developers prefer to receive OTS in source code format, software vendors prefer to provide their software in object code format for several reasons. One reason relates to intellectual property. Because source code can be easily read and understood, a competitor could review this text to discover how the software works. As a result, if software were distributed in source code form, rival vendors could readily take and reuse parts of the software in their competing products. Providing software in object code format hides and protects proprietary secrets in the software. Another problem for software vendors is unauthorized modification of software. Some software vendors do not want their code modified once it is released. It is nearly impossible to modify software when it is in object code format.

The present invention addresses the foregoing conflict and other problems and provides a method and apparatus for secure code delivery. In one embodiment one or more software components are delivered to developer's computer in encrypted source code form along with a license to use the software. The developer's computer may include a module for decrypting the components so that they can be processed by tools (e.g., viewers, compilers, debuggers, etc.), depending on access privileges contained in the license. The present invention can also prevent a developer from copying the decrypted software components to a hard disk or to a memory device external to the developer's computer. These features and other will be more fully described below.

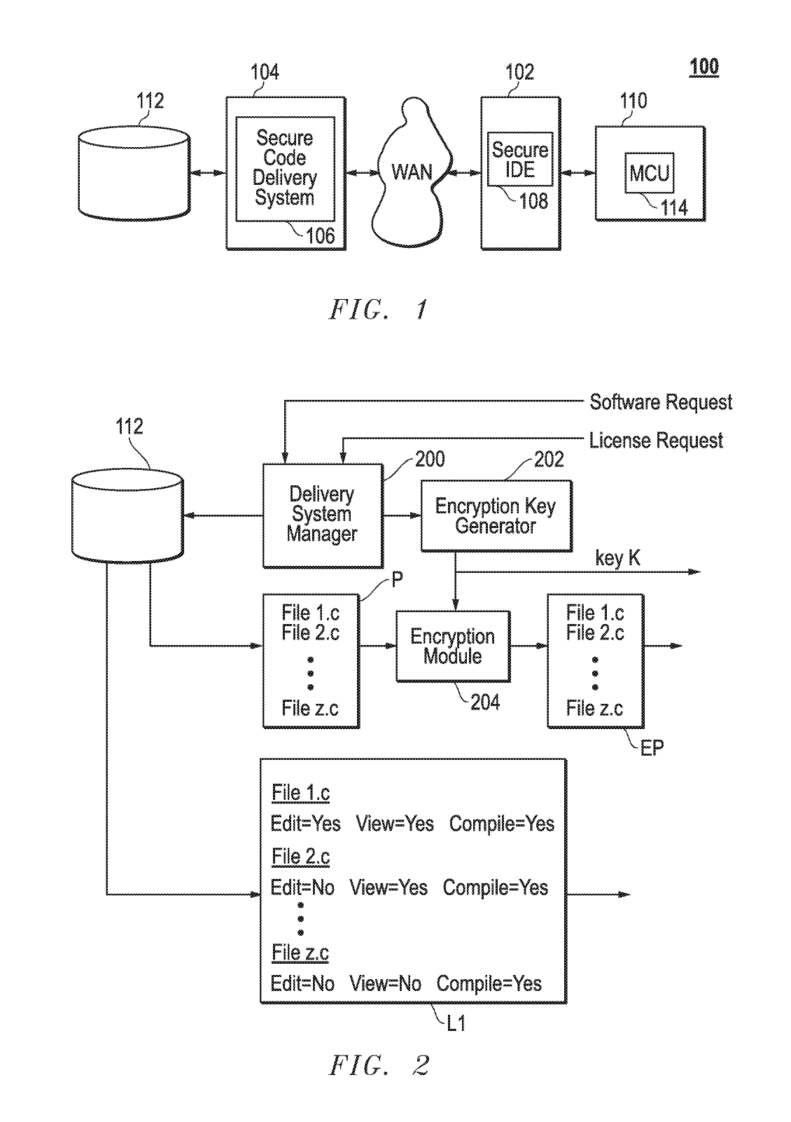

FIG. 1 illustrates a system 100 in block diagram form, which employs one embodiment of the present invention. While the present invention will be described with reference to FIG. 1, it is understood that the present invention should not be limited thereto.

System 100 includes a general purpose computer 102 coupled to server 104 via a wide area network (WAN) such as the Internet. Server 104 is coupled to memory 112 that stores files containing software platform components in source code format. In one embodiment, memory 112 contains sample embedded application code and most if not all software platform components that are needed to build embedded software that can be programmed into a variety of MCUs. The software platform components stored in memory 112 can be provided by different software vendors, who have agreed to license their software for use by developers via secure code delivery system 106.

Server 104 includes a secure code delivery system 106, which is configured to send software packages and corresponding licenses to computers like computer 102 in response to receiving requests from developers. Each package includes one or more files from memory 112, each containing a software platform component needed for an embedded software project. In one embodiment, secure code delivery system 106 sends one or more the requested software platform components in files of encrypted source code to computer 102. The files are individually encrypted before being packaged together and sent to computer 102 via the WAN. Sever 104 also sends a license that defines the access privileges for each encrypted software component included in the corresponding software package. Server 104 sends licenses in read-only files. Server 104 can also send an updated license that upgrades the access privileges for previously sent encrypted software components.

FIG. 2 illustrates an example secure code delivery system 106 employed in FIG. 1. Secure code delivery system 106 includes a delivery system manager 200 in data communication with an encryption key generator 202 and an encryption module 204. Each of these components takes form in instructions executing on one or more processors of server 104.

Secure code delivery system 106 is configured to create and transmit a package to computer 102 that contains one or more encrypted files of software platform components in source code form. The present invention will be described with reference to secure code delivery system 106 transmitting a package EP of files containing encrypted software platform components. For example, package EP may include a file containing an encrypted RTOS that provides advanced scheduling facilities, message passing, interrupt management, messaging services, etc. Package EP may also include files containing encrypted TCP/IP stack, application layer protocols (e.g., file transfer protocol (FTP), Hypertext Transfer Protocol (HTTP), etc.), drivers, a board support package (BSP), etc. Package EP may further include files containing a collection of encrypted framework components that provide different functionalities. These different functionalities are interoperable with the RTOS features to manage resource conflicts and synchronize between multiple threads. Many of the framework components use each other's services when integrated into a software platform.

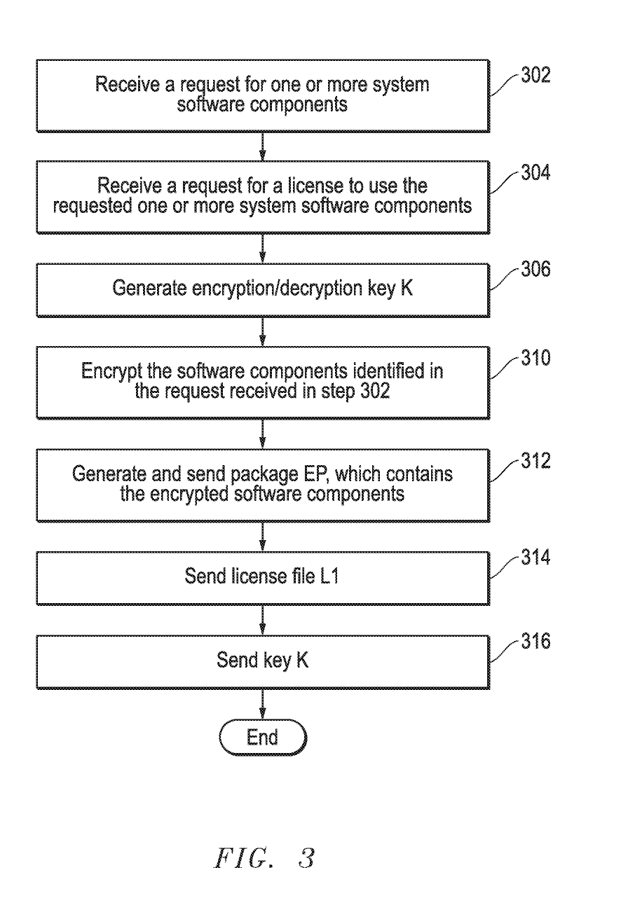

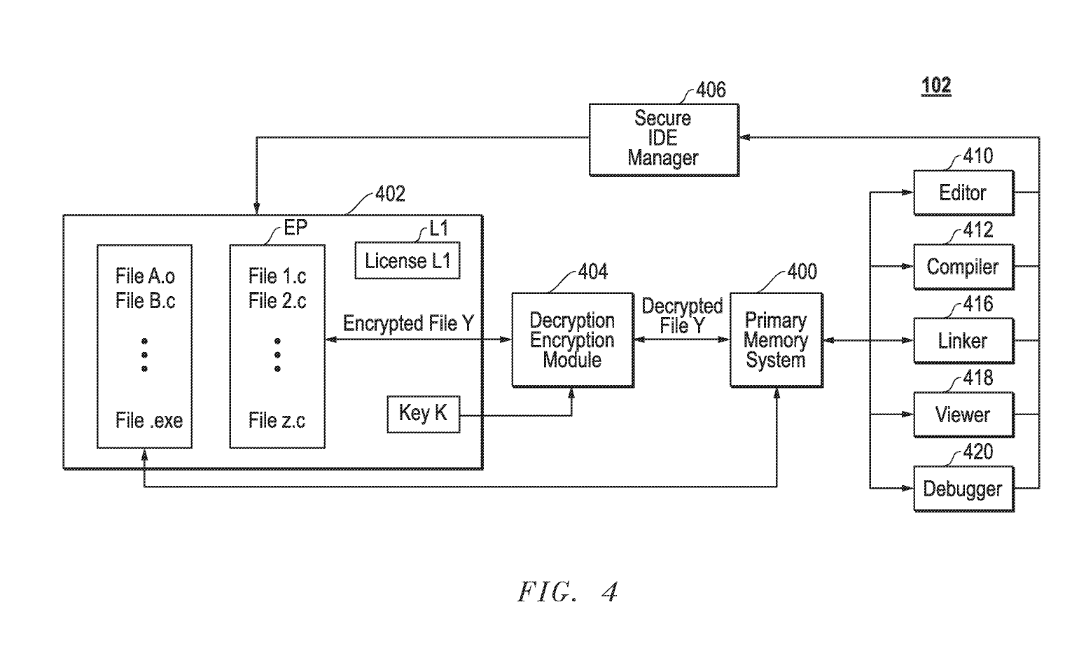

FIG. 3 illustrates one process implemented by secure code delivery system 106 for sending package EP of encrypted software components in source code format to computer 102. It is noted that package EP can also include software components in source or object code format that are not encrypted. The present invention will be described with reference to package EP containing multiple files, each containing encrypted source code, it being understood the present invention should not be limited thereto.

The process shown in FIG. 3 starts with step 302 when delivery system manager 200 receives a request for package EP from computer 102. Delivery system manager 200 may also receive a request for a license to use software platform components of package EP as shown in step 304. A license defines a set of user access privileges for each file that contains encrypted source code. In one embodiment, the privileges of a set allow or disallow access for the purpose of editing source code, viewing source code, compiling source code, etc., of the file. The license is configurable, and licenses sent to developers can vary in access privileges. In other words, two developers seeking the same package may request and subsequently receive different access privileges for identical files contained therein. The requested license can be one or several predetermined licenses that are offered to developers.

Encryption is a process of encoding information in such a way that only authorized parties can read it. The contents of an encrypted file cannot be read until it is decrypted, and the contents of an encrypted file cannot be decrypted without a decryption key. There are several different types of encryption systems that can be employed in with the present invention. In a public-key encryption system, the contents of a file may be encrypted using a public key, but the file can be decrypted only with a private key. Both the private and public keys can be generated by secure code delivery system 106. The strength of a public-key system relies on the degree of difficulty (computational impracticality) for a properly generated private key to be determined from its corresponding public key. In contrast private key encryption systems use the same key for both encryption and decryption. The present invention will be described with reference to use with a private key encryption system, it being understood the present invention should not be limited thereto.

Returning to FIG. 3, in step 306, encryption key generator generates a key K that is unique to the request received in step 302. Delivery system manager 200 retrieves source code files to be included in package EP. In one embodiment, the files retrieved may be identified in the request received in step 306. Encryption module 210 encrypts the content of the retrieved files using key K. Delivery system 106 creates package EP of encrypted files and sends it to computer 102 as shown in step 312. Delivery system 106 also sends a read-only license file that includes access privileges for encrypted files in the package EP. FIG. 2 illustrates an example package EP and a corresponding example read-only license file L1. The license file L1 has access privileges for each of the encrypted files of package EP. In step 316, key K is transmitted to the developer's computer 102 in a separate message.

With continuing reference to FIGS. 1 and 2, FIG. 4 illustrates relevant components of an example computer system 102 implementing a secure IDE 108. In general the memory hierarchy of computers, such as computer 102, includes: CPU registers; CPU caches; primary memory; and secondary memory 402. Computer 102 includes primary memory 400 (often referred to as main memory by those skilled in the art), which for purposes of explanation includes random access memory (RAM).

Secondary memory 402, which for the purpose of explanation only, takes form in a hard disk. Secondary memory 402 receives and stores the encrypted package EP, read-only license file L1 and key K received from server 104. Additionally, secondary memory 402 includes additional files containing source code or object code that are accessible by secure IDE 108 or tools thereof.

Primary memory is the area in a computer in which data, including instructions of decrypted software components, is stored for quick access by the computer's CPU via CPU registers and CPU caches (not shown). Primary memory 400, not secondary memory 402, is directly accessible by the CPU of computer 102 via CPU registers and CPU caches. The CPU continuously reads instructions stored there and executes them as required. Any data actively operated on is also stored there in uniform manner.

Computer 102 includes secure IDE 108, which in turn includes a secure IDE manager 406 in data communication with an encryption/decryption module 404 and software development tools 410-420. In one embodiment, the development tools include source code editor 410, compiler 412, linker 416, secure viewer 418 and debugger 420, which are chained together to enable development of embedded software using components provided in package EP. Each component 404-420 of secure IDE 108 takes form in instructions executing on one or more processors. In one embodiment secure IDE 108 is downloaded to computer 102 from server 104 via the WAN. Secure IDE 108, in an alternative embodiment, can be provided as software as a service on server 104 or another server (not shown) coupled to a developer's computer system via the WAN and accessible via a browser. However, the present invention will be described with reference to secure IDE implemented on computer system 102, it being understood the present invention should not be limited thereto.

Module 404 implements a decryption algorithm. In another embodiment module 404 implements both an encryption algorithm and a decryption algorithm. The encryption algorithm can be the same encryption algorithm implemented by encryption module 204 of secure code delivery system 106. The encryption algorithm of module 404, if employed therein, can encrypt source code held in primary memory 400 that has been modified. The encrypted, modified source code can then be stored in secondary memory 402. This encryption may use key K. More importantly, encryption/decryption module 404 can decrypt the content of files of package EP using key K. The output (i.e., decrypted source code) of encryption/decryption module 404 is stored in primary memory 400 where it can be subsequently accessed and processed by one of the software development tools 410-420, presuming license file L1 allows the tool to access and process the decrypted source code as will be more fully described below.

Decrypted source code is stored in primary memory 400 with copy protection so that decrypted source code or edited, decrypted source code cannot be copied from primary 400 to secondary memory 402 or another memory device external to computer 102. Copy protection can be implemented in any one of many different ways. For example, primary memory 400 can be divided into secure and non-secure regions. Encryption/decryption module 404 can be configured to only store decrypted source code output in the designated secure area of primary memory 400. Any attempt to copy data from the secure region of primary memory 400 to secondary memory 402 or to any memory device external to computer 102, can be blocked by secure IDE 108, the operating system (not shown) of computer 102, the file system manager (not shown) of computer 102, or other components internal or external to computer 102.

Each of the development tools 410-420 can request access to a file of package EP that contains encrypted source code after it is decrypted. For example, editor 410 may request access to edit the source code of a file after it is decrypted, or editor 410 may request access to display the source code via secure viewer 418. Compiler 412 may request access to compile the source code of a file after it is decrypted. Debugger 420 may request access to display decrypted source code via secure viewer 118 during debugging. Other access requests are contemplated.

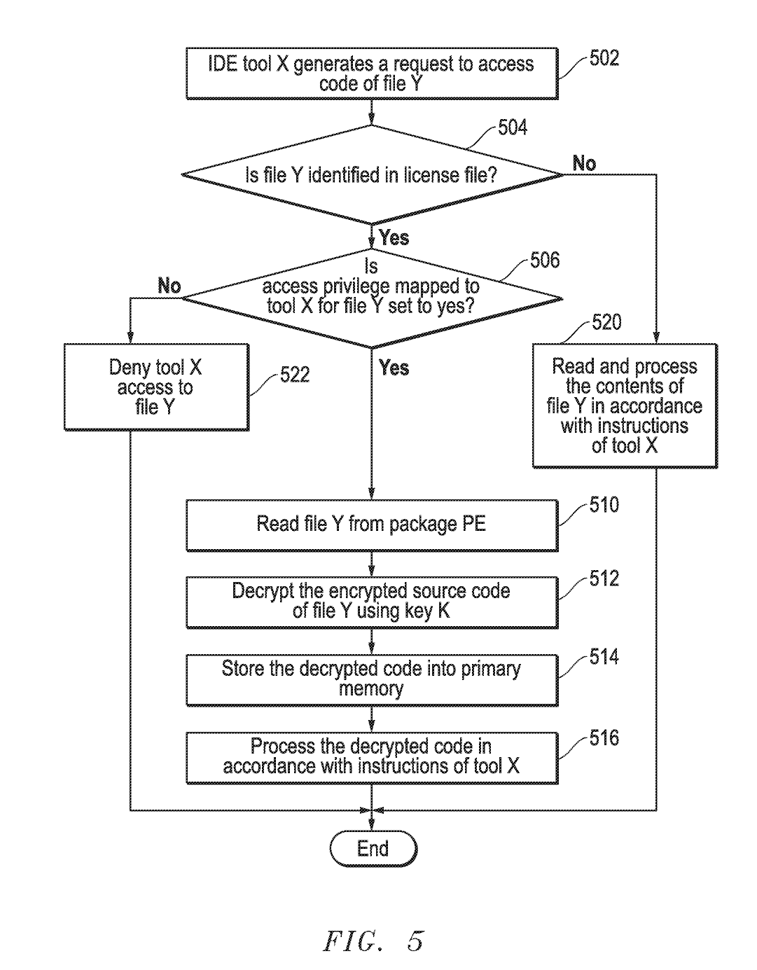

With continuing reference to FIGS. 2 and 4, license file L1 defines access privileges for each file of encrypted package EP. In one embodiment, license L1 includes a set of access privileges for each encrypted file. In the illustrated example, each set includes individual access privileges for compiling, editing, and viewing the source code after decryption. Additional access privileges are contemplated.

IDE manager 406 performs several functions, one of which is to manage access requests of tools 410-420. Each access request should identify a file and the tool that generated the request. If the file is encrypted, IDE manager 406 will access license L1 using the file and tool identities in the request, to determine whether to grant or deny the request. For example, IDE manager 406 will deny a request from compiler 412 to compile code of an encrypted file if the “compile” privilege for that file is set to “No,” and IDE manager 406 will grant the request if the “compile” privilege is set to “Yes.” Similarly IDE manager 406 will grant a request from editor 210 to edit code of an encrypted file only if the “edit” privilege is set to “Yes.” Once edited, the source code can be re-encrypted by encryption/decryption module 404 before it is returned back to secondary memory 402 for storage. Alternatively, the edited source code can be returned to secondary memory 402 without re-encryption where it replaces the originally encrypted source code, and thereafter the edited source code is treated as plain text (i.e., not subject to access privilege checking) by the IDED manager 406. IDE manager 406 will deny a request from editor 210 or debugger 220 to display decrypted source code of an encrypted file in EP if the “view” privilege for that file is set to “No.” The “view” access privilege allows decrypted source code file to be displayed, but not edited.

Before any encrypted file is accessed by a tool, the contents of an encrypted file must be decrypted. Encryption/decryption module 404 can perform this function using key K. Encryption/decryption module 404 stores the decrypted results within the secure region of primary memory 400 mentioned above. Thereafter, the tool requesting access can process the decrypted source code, assuming the tool has been granted permission by IDE manager 406. Importantly, the decrypted source code or portions thereof can only reside in primary memory 400, or the CPU caches and registers. In other words, decrypted source code cannot be copied from primary memory 400 to secondary memory 402 or any memory device external to computer 102.

As noted above, secure IDE manager 406 governs access to decrypted source code. FIG. 5 illustrates an example process implemented by the IDE manager 406 with respect to files of package EP that contain encrypted source code in accordance with one embodiment of the present invention. It is again noted that in alternative embodiments, package EP may contain files of source code that are not encrypted. These files need not be processed in accordance with the method of FIG. 5. However, the remaining disclosure will presume that all files of package EP contain encrypted source code.

As shown in FIG. 5 the process starts when tool X (e.g., secure viewer 418) generates a request to access code contained within a file Y for a specific reason (e.g., access to display). IDE manager 406 checks to see if file Y is identified in license file L1. If not, file Y is not an encrypted file of package EP, and the file is copied from secondary memory 402 to primary memory 400 for subsequent access in accordance with the instructions of tool X. If, however, file Y is identified in license L1 then file Y is encrypted, and secure ID manager 406 accesses license file L1 to determine the access privilege of file Y by tool X. In this embodiment, secure ID manager 406 reads the access privilege mapped to tool X for file Y. If this access permission or privilege indicates that tool X has permission to access and process the source code in file Y, then file Y is retrieved from secondary memory 402 and decrypted, the result of which is placed within a secure region of the primary memory 400. Thereafter, tool Y can process the decrypted source code of file Y in accordance with the access request. If, however, secure ID manager 420 determines that tool X does not have permission to access file Y for the reason identified in the request, then a message is generated indicating that access is denied and the process ends. The message could be displayed via graphical user interface of computer system 102 (not shown).

To place the process shown in FIG. 5 in context, secure viewer 418 may generate a request to view the contents of an encrypted File1.c in response to a request from debugger 420. In response, secure ID manager 406 accesses the license L1 to ascertain the view privilege for File1.c. If the view privilege is set to “Yes,” then the contents of File1.c is decrypted and stored in the secure area of primary memory 400. Viewer 418 may in turn display the decrypted source code to a developer. If, however, the “view” access privilege mapped to File1.c is set to “No,” then secure ID manager 406 will deny the view access request and possibly generate an error message.

Because decrypted source code of a file is only stored within a secure area of primary memory 400, the decrypted source code cannot be copied and distributed. Moreover, if the decrypted source code is mapped to an edit access privilege set to “No,” the decrypted source code cannot be modified. However, the present invention allows developers to compile source code using desired configurations for their projects. Moreover, the present invention allows developers to view source code during a debugging process, which enables a more efficient and easier process for correcting bugs within embedded software.

Secure IDE manager 406 manages requests to access files of encrypted package EP. Secure IDE manager 406 performs other functions. For example, secure IDE manager 406 can generate or request another module to generate a signature for any one of the tools 410-420 the requests access to encrypted source code. A signature for a tool can be generated as a function of the code thereof using any one of many well-known processes such as computer check sum (CSC). The generated signature for a tool can be compared with authorized signatures stored in memory. If the generated signature does not match an authorized signature, secure IDE manager 406 should deny any access request by the tool.

Although the present invention has been described in connection with several embodiments, the invention is not intended to be limited to the specific forms set forth herein. On the contrary, it is intended to cover such alternatives, modifications, and equivalents as can be reasonably included within the scope of the invention as defined by the appended claims.

What is claimed is:

1. A method implemented on a computer system, the method comprising:
reading an access privilege from a first set of access privileges of a license file, wherein the first set of access privileges corresponds to a first file that comprises first encrypted source code,
decrypting the first encrypted source code to produce first decrypted source code;
determining whether the first access privilege is set to a first state or a second state;
in response to determining the first access privilege is set to the first state, a first software development tool accessing the first decrypted source code.

2. The method of claim 1 wherein the first software development tool is one of a plurality of software development tools of an integrated development environment.

3. The method of claim 2 wherein the access privileges of the first set correspond to the software development tools, respectively.

4. The method of claim 3 further comprising:
after the first software development tool processes the first decrypted source code, reading a second access privilege of the first set;
determining whether the second access privilege is set to the first state or the second state;
in response to determining the second access privilege is set to the second state, denying access of a second software tool to the first file or decrypted contents thereof;
wherein the second access privilege corresponds to the second software development tool of the plurality of software development tools.

5. The method of claim 3:
wherein the computer system comprises a primary memory system and a secondary memory system;
wherein the decrypted first source code is stored in the primary memory system;
wherein the method further comprises an act of blocking any attempt to copy the decrypted first source code from the primary memory system to the secondary memory system.

6. The method of claim 5 further comprising:
after the first software development tool processes the decrypted first source code, reading a second access privilege of the first set;
determining whether the second access privilege is set to the first state or the second state;
in response to determining the second access privilege is set to the first state, decrypting the contents of the first file to reproduce the decrypted first source code;
overwriting the first source code in the primary memory system with the reproduced, decrypted first source code;
a second software development tool processing the reproduced, decrypted first source code.

7. The method of claim 1 wherein the first source code comprises code of a real time operating system.

8. The method of claim 1 wherein the first software development tool comprises a compiler or a debugger.

9. A method comprising:
a server transmitting instructions to a computer system via a wide area network, wherein the computer system implements a method for building embedded software in response to the computer system executing the instructions, the method for building the embedded software comprising:
reading an access privilege from a first set of access privileges of a license file, wherein the first set of access privileges corresponds to a first file stored in secondary memory of the computer system that comprises first encrypted source code, decrypting the first encrypted source code to produce first decrypted source code;
determining whether the first access privilege is set to a first state or a second state;
in response to determining the first access privilege is set to the first state, a first software development tool accessing the first decrypted source code.

10. The method of claim 9 wherein the first software development tool is one of a plurality of software development tools of an integrated development environment.

11. The method of claim 10 wherein the access privileges of the first set correspond to the software development tools, respectively.

12. The method of claim 11 wherein the method for building the embedded software further comprises:
after the first software development tool processes the first decrypted source code, reading a second access privilege of the first set;
determining whether the second access privilege is set to the first state or the second state;
in response to determining the second access privilege is set to the second state, denying access of a second software tool to the first file or decrypted contents thereof;
wherein the second access privilege corresponds to the second software development tool of the plurality of software development tools.

13. The method of claim 11:
wherein the computer system comprises a primary memory system and a secondary memory system;
wherein the decrypted first source code is stored in the primary memory system;
wherein the method further comprises blocking any attempt to copy the decrypted first source code from the primary memory system to the secondary memory system or any other memory system.

14. The method of claim 13 wherein the method for building the embedded software further comprises:
after the first software development tool processes the decrypted first source code, reading a second access privilege of the first set;
determining whether the second access privilege is set to the first state or the second state;
in response to determining the second access privilege is set to the first state, decrypting the contents of the first file to reproduce the decrypted first source code;
overwriting the first source code in the primary memory system with the reproduced, decrypted first source code;
a second software development tool processing the reproduced, decrypted first source code.

15. The method of claim 9 wherein the first source code comprises code of a real time operating system.

16. The method of claim 9 wherein the first software development tool comprises a compiler or a debugger.

17. An apparatus comprising:
a circuit for reading an access privilege from a first set of access privileges of a license file stored in a first memory, wherein the first set of access privileges corresponds to a first file that comprises first encrypted source code,
a circuit for decrypting the first encrypted source code to produce first decrypted source code;
a circuit for storing the first decrypted source code in a second memory;
a circuit for determining whether the first access privilege is set to a first state or a second state;
a first software development tool for accessing the first decrypted source code stored in the second memory.

18. The apparatus of claim 17 wherein the first software development tool is one of a plurality of software development tools of an integrated development environment.

19. The apparatus of claim 18 wherein the access privileges of the first set correspond to the software development tools, respectively.

20. The apparatus of claim 17 wherein the first software development tool comprises a compiler or a debugger.
